(19) United States
(12) Patent Application Publication
(10) Pub. No.: US 2007/0245373 A1
(43) Pub. Date: Oct. 18, 2007

(54) Method for configuring media-playing sets

(75) Inventors: Vishnu-Kumar Shivaji-Rao, Vancouver, WA (US); Fernando Amat Gil, Stanford, CA (US); Bryan Severt Hallberg, Vancouver, WA (US)

Correspondence Address: KEVIN L. RUSSELL;CHERNOFF, VILHAUER, MCCLUNG & STENZEL LLP, 1600 ODSTOWER, 601 SW SECOND AVENUE, PORTLAND, OR, 97204, US

(73) Assignee: Sharp Laboratories of America, Inc.

(21) Appl. No.: 11/395,507

(22) Filed: Mar. 31, 2006

(51) Int. Cl. H04N 5/445; H04N 7/10; H04N 7/025; G06F 13/00

(52) U.S. Cl. 725/35; 725/34; 725/45

(57) ABSTRACT

An exemplary method to help end users configure their respective media playing sets includes prompting the user for their geographical location, transmitting the location to a remote processing site which identifies broadcast settings particularly suited for the location, and adjusting the set remotely from the site to fully implement automatically the settings. Another such method includes establishing a list of viewing categories, identifying preferred broadcast settings for each category, determining preferred categories for previous day/time combinations, predicting most likely to favored categories and settings, and automatically implementing such settings when the corresponding day/time combination is present. Yet another such method includes characterizing a particular program segment by at least one broadcast attribute, determining those broadcast settings most favorable for this segment based on such characterizing, and adjusting the set automatically for the user to implement these most favorable broadcast settings for the segment.

### CROSS-REFERENCE TO RELATED APPLICATIONS

Not applicable.

### BACKGROUND OF THE INVENTION

The present invention relates to helping end users configure their media-playing sets and, in particular, to helping users adjust the settings on their sets so that these settings are well-suited to the programming available or being viewed.

As technology has developed, media-playing sets are being manufactured with increasingly sophisticated and complex features. For example, advanced signal decoding circuitry in modern televisions allows them to receive signals from a variety of broadcasting source types, including network TV, satellite TV, and broadband cable TV. Moreover, some televisions are equipped for decoding images received over the Internet while personal computers increasingly are able to play media that traditionally was reserved for television such as feature-length films. Consistent with the concept of the home entertainment center, a media-playing set can be composed of a number of pieces of equipment, each designed for playing one or more separate media types, such as a television, stereo, videorecorder, DVD player, personal computer, compact disk player, and so on.

As a result of advances in technology, where once the user had three or four network channels to select from, now there can easily be over a hundred satellite channels to choose between. With so many channels, it can be difficult to set up all of them properly. For example, some sets construct a local channel map by scanning the different channels with their signal detection circuitry; however, this process not only takes some time but frequently misses existing or good channels and adds blank or unreliable channels. After setup is complete, each time the user wishes to change the channel, he or she is faced with a somewhat bewildering number of choices. Furthermore, once the user has made a particular channel selection, in attempting to optimize the picture and sound settings for the particular type of programming being received, the user is often required to manually adjust the controls of the set through a process of trial and error. He or she hopes to at last hit upon a combination, for example, of brightness, backlight, color, contrast, tint, and sharpness for the picture or treble, bass, and balance for the audio, providing an adequate broadcast quality. Even a relatively simple setting, like the clock, may mean going through a series of on-screen menu selections, not to mention the added inconvenience of finding, as a point of reference, an accurate timepiece with the precise time.

To complicate matters, different types of media are best presented with different settings. Some media are recorded with a 16:9 aspect ratio while others are recorded in 4:3 format. Although there are some sets or televisions that store multiple picture setup modes, such as standard mode, movie mode, game mode, and so on, this solution frequently does not adequately address the concern. For example, though each is categorized as a movie, modern movies often look better with settings different from classic movies or colorized movies. Often animated movies look best with still other settings, and so on. Likewise, images transmitted over the Internet to a media-playing set can be formatted a variety of ways and look best under correspondingly different settings.

### BRIEF SUMMARY OF THE INVENTION

Based on the foregoing, then, it is an object of the present invention is to provide an enhanced procedure for helping end users configure their respective media-playing sets.

In accordance with a first aspect of the present invention, such a method is provided including prompting the user to identify their respective geographical location, transmitting information specifying this location to a processing site remote from the set, identifying at this site at least one broadcast setting particularly suited for the location, and adjusting the set remotely from the site so as to fully implement automatically this at least one broadcast setting. In this manner, the user has immediate access to the broadcast setting identified as suitable by the remote site with its superior access to computing and informational resources independently of any need for recourse by the user to inconvenient and tedious manual setup procedures. The broadcast setting can, for example, be an accurate clock setting or suitable listing of channels. In the latter instance, a more complete listing of channels is more quickly constructed than, for example, with an automatic detection approach which frequently adds bad channels, misses good channels, and takes significantly more time to complete its scanning process.

In accordance with a second aspect of the present invention, such a method is provided including establishing a list of viewing categories and identifying a preferred broadcast setting for each viewing category; determining preferred ones of these viewing categories for the user for previous day-of-week and time-of-day combinations and, based thereon, predicting most likely to be favored ones of these viewing categories for the user for pending day-of-week and time-of-day combinations; and based on the above steps, predicting a most likely to be favored broadcast setting for the user for each of various pending day-of-week and time-of-day combinations and automatically implementing this most likely to be favored broadcast setting at said set when the corresponding day-of-week and time-of-day combination is present. This procedure enables the broadcast settings for the set to be efficiently implemented automatically without requiring the user to adjust the set by inconveniently working their way through multiple on-screen menu lists containing equally plausible settings to choose between or by manually adjusting the controls using a laborious trial-and-error approach. The broadcast setting is also more likely optimized for the user since it represents a preferred broadcast setting for a particular viewing category that, in turn, is most likely to be favored by the user during the occurrence of a particular day-of-week and time-of-day combination.

In accordance with a third aspect of the present invention, such a method is provided including characterizing a particular program segment by its broadcast attributes, determining those broadcast settings most favorable for the particular program segment based on this characterizing step, and adjusting the set automatically for the user to implement these most favorable broadcast settings for the particular program segment. Again, the set is efficiently adjusted for the user without requiring the user to work through protracted adjustment procedures involving on-screen menus or manual controls. Also, by doing the characterizing at the program segment level, instead of at the more general media type level, the broadcast settings are optimized more closely for the actual program segment encountered by the user.

The foregoing and other objectives, features, and advantages of the invention will be more readily understood upon consideration of the following detailed description of the invention, taken in conjunction with the accompanying drawings.

### BRIEF DESCRIPTION OF THE SEVERAL VIEWS OF THE DRAWINGS

FIG. 1 is a diagrammatic view of an exemplary system for helping end users configure their respective media-playing sets in accordance with the present invention.

FIG. 2 is a schematic view showing details of the system of FIG. 1 where the media-playing set is a digital television.

FIG. 3 is a flowchart of a first exemplary method involving implementing automatically at least one broadcast setting particularly suited for the user's geographical location.

FIG. 4 is a flowchart showing the steps involved in implementing most likely to be favored broadcast settings based on various day and time combinations as outlined in accordance with a second exemplary method of the present invention.

FIG. 5 is a listing of viewing categories established in accordance with the exemplary method of FIG. 4.

FIG. 6 shows a table listing preferred broadcast settings for different viewing categories, as arrayed by column, and different series of broadcast settings, as arrayed by row, as depicted in accordance with the exemplary method of FIG. 4.

FIGS. 7 and 8 show preferred ones of the viewing categories for the user individually and for a group of like viewing habits, respectively, for previous day and time combinations as determined in accordance with the exemplary method of FIG. 4.

FIGS. 9-11 show, in pie chart form, a ranking of broadcast settings (the larger the slice, the more preferred the setting) for various series of broadcast settings (time, channels, and input signal) and all for a particular viewing category, here Childrens, as determined in accordance with the exemplary method of FIG. 4.

FIG. 12 represents, in bar graph form, the preferred broadcast setting for three different viewing categories (Sports, Children, and Thriller) for a number of different series of picture and audio settings of the type that take a range of potential values and as determined in accordance with the exemplary method of FIG. 4.

FIG. 13 shows, while the user is tuned to the viewing category Action and Adventure, how preferred broadcast “solutions” (each comprised of multiple settings) are preferably implemented while concurrently maintaining the user's original “solution” in accordance with the exemplary method of FIG. 4.

FIG. 14 shows the parental control function, which is a most likely to be favored broadcast setting for the time shown, being automatically implemented for a weekday afternoon in accordance with the exemplary method of FIG. 4.

FIG. 15 is a flowchart showing the steps involved in adjusting the broadcast settings for a particular program segment in accordance with a third exemplary method of the present invention.

### DETAILED DESCRIPTION OF PREFERRED EMBODIMENT

I. System Architecture

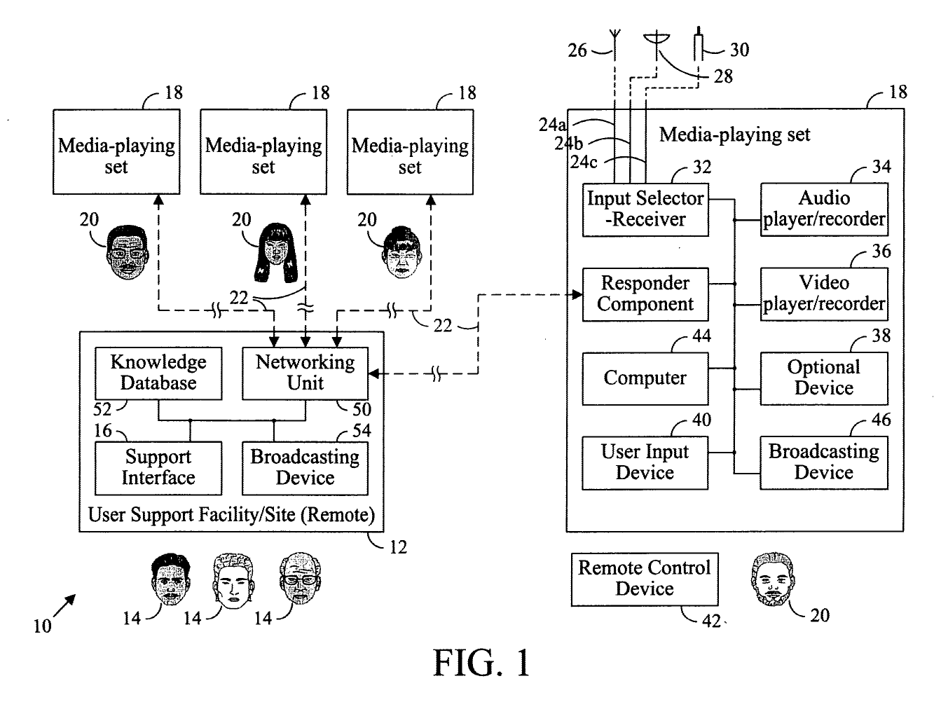

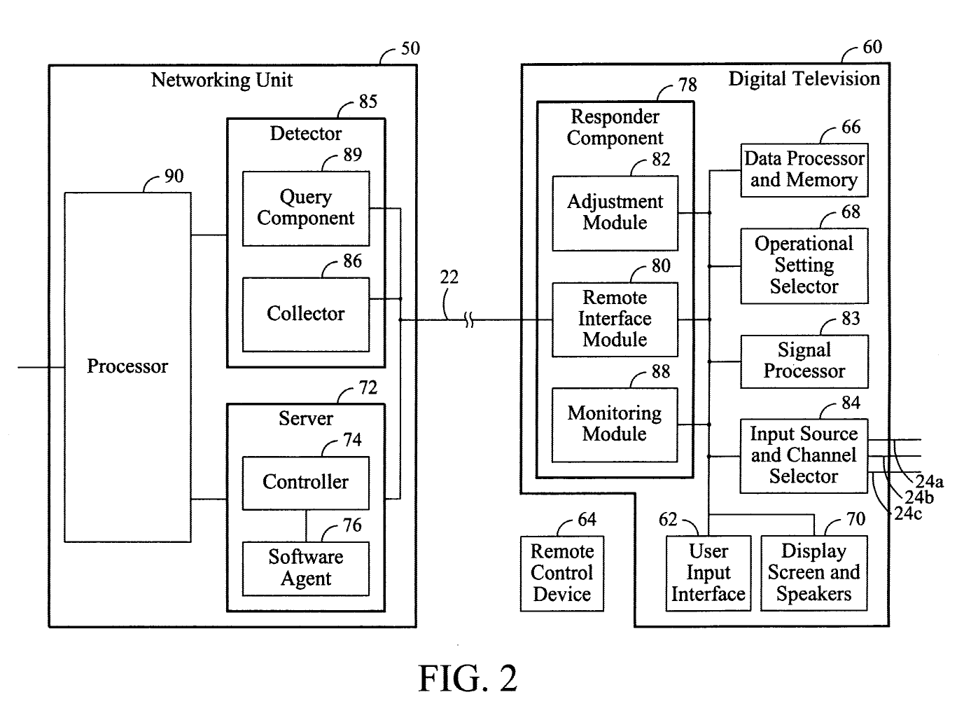

FIG. 1 shows an exemplary system 10 for implementing the exemplary methods described below under separate Roman Numeral headings. This exemplary system was originally illustrated and described in a related U.S. application as referenced above. The subject matter of this related application is hereby incorporated fully by reference herein. FIG. 1 is included in this continuation-in-part application, with renumbering of the elements from the original, in order to better describe and illustrate the system based features preferably available for implementing the exemplary methods of the present invention. The same holds for FIG. 2.

The system of FIG. 1 includes a customer support facility or site 12 that optionally may be staffed by customer support representatives 14 who would then interface with the resources provided at the site through a support interface 16 such as a terminal workstation. Preferably, however, the remote site operates substantially automatically as further explained below.

The support site 12 is remotely interconnected to the respective media-playing sets 18 of different end users 20 who are in geographically distributed relationship to one another. The term “remotely,” as used herein and in the claims, is intended to denote sufficient physical separation that a particular end user would not have convenient access to the support site from his household or quarters. Interconnection can be temporarily established through conventional networking systems, as indicated by the network lines 22 shown in dashed-line form. For example, interconnection can be made through conventional telephone lines using a dial-up Internet application, or through digital subscriber or cable line or through satellite link. Desirably the connection is made through secure means, such as Secure Socket Layers (SSL) technology, to prevent the unauthorized monitoring of the viewing preferences of one user by another. The support site centrally provides the computing resources and expertise needed to efficiently configure and optimize each set and also enables efficient and cost-effective updating of information needed for the optimization process.

As indicated in FIG. 1, each media-playing set 18 can be variously configured. Typically, the media-playing set will be capable of receiving signals from various external input sources through respective input lines 24a-c. For example, where the set is a digital television, these sources can include a network broadcast antenna 26, satellite dish 28, or cable television link 30, The input selector-receiver 32 automatically demodulates the type of input signal selected. These input signals are typically multiplexed and are not only divided into different program segments or “shows” but also contain header information or “metadata” (data about data) for each show that contains a representative title page, the day-of-week and time-of-day of broadcast, a corresponding channel station identifier, and information that can be decoded to be used for presenting an on-screen Electronic Programming Guide (EPG). This EPG information can include the general theme of the particular program segment, such as “documentary,” a capsule synopsis of the segment's content, the director, the principal actors, and other such information as might be usefully listed with the channel to serve as an on-screen viewing guide for the end user.

In addition to receiving signals from various external sources and selectively tuning to a particular program segment, the input selector-receiver can also receive and process signals from any internal devices included in the set, such as from a compact disc player or other audio player/recorder 34, from a DVD or other video player/recorder 36, or from some other optional device 38. A user input device 40, such as a bank of front-panel buttons, permits the user to operate the various devices of the set or, if the user prefers, his or her adjustments can be entered via a remote control device 42. These entries are recognized and executed by the computer 44 and the broadcast is directly conveyed to the user through broadcasting device 46, representing, for example, a bank of speakers and a display screen.

A responder component 48 relays information about the set to the remote site, specifically a networking unit 50 at the site, and also receives control information back for automatically adjusting the broadcast settings of the set. The term “broadcast settings” as used herein and in the claims is intended to broadly denote any selections that the user may potentially choose that influence the broadcast as perceived by the user. Any variations of this term are intended to have the same meaning identified in the related U.S. patent application referenced above. A knowledge database 52 stores information about the viewing preferences of each user and can be readily accessed by the networking unit, as needed, to determine which broadcast settings will be optimal for each set in accordance with the methods described hereinbelow under separate Roman Numeral heading. Broadcasting device 54 replicates the broadcast transmission (for example, pictures and sounds) presented to the user by the broadcasting device 46 so that the customer service representatives 14, when the remote site is optionally staffed, can see and hear just what the user is seeing and hearing.

FIG. 2 shows details of a typical configuration of the media-playing set 18 of FIG. 1 as well as details of the networking unit 50 at the remote site 12. Here the media-playing set is a digital television 60, which the user can operate through a user input interface 62, such as depressible buttons on the set's front panel, or through a remote control device 64. To the extent the entered commands relate to operational settings, such as picture and sound, they are translated by the data processor and memory 66 for execution by the operational setting selector 68 which, in response, suitably adjusts the broadcast characteristics of the display screen and speakers 70 to perform the desired adjustment. If the commands are remotely received, as from the server 72 located within the networking unit 50 or, more specifically, from the controller 74 and software agent 76 of this server, these commands are input to the responder component 78 of the set. There they are relayed by a remote interface module 80 within the responder to the adjustment module 82 which directs the operational setting selector to make the desired adjustment as before.

If the commands entered by the user relate to setup selections, such as which external input source line 24a-c to access, or to viewing selections, such as which particular channel segment or “show” to tune to, these commands are interpreted by the data processor and memory 68, and appropriate instructions are sent to the signal processor 83 and input source and channel selector 84 so that, for example, the desired source is selected, appropriate demodulation of the signal occurs, and the broadcast transmission is tuned to the particular channel segment or show desired. Again, this process is controllable remotely by the remote server 72 by means of control commands sent to the interface module 80 that are then relayed to the adjustment module 82, which adjustment module then directs the signal processor and input source and channel selector to implement the desired settings.

Particularly where the remote site 12 (FIG. 1) is operating automatically without any customer service representatives 14 being present, preferably the networking unit 50 includes a mechanism for automatically collecting information about the set, such as a detector 84. In the embodiment shown in FIG. 2, this detector includes a collector 86 for receiving status information from the monitoring module 88 of the digital television via the remote interface module 80. This status information is desirably gathered including from the operational setting selector 68, signal processor 83, and input source and channel selector 84. That is, it includes information identifying the current broadcast characteristics of the set, including characteristics relating to setup settings, operational settings (e.g., picture and sound) or the signal characteristics of a particular media or channel segment being viewed. A query component 89 can remotely prompt the user for any further status information needed, such as the user's geographical location, or the user can telephone in this information, or a self-executing script, stored in memory 66 or on removable media such as a setup CD, can be used to perform this function. A remote processor 90 receives this information about location, signal characteristics and current settings from the detector and, in accordance with the methods described below under separate Roman Numeral heading, is able to identify broadcast settings particularly well-suited for the set. To perform this task, the processor has access to the knowledge database 52 (FIG. 1) which holds information about individual and group viewing preferences and/or expert opinions on preferred settings for various viewing categories as well as about various media signal characteristics.

The foregoing description of the exemplary system 20 is designed to be illustrative of a preferred environment in which the below described methods are implemented, and it will be apparent, to those of ordinary skill in the art, that the functional blocks described can be combined and divided differently without substantial loss of functionality in carrying out these methods. It will be especially noted that though the present system and methods have particular applicability to televisions, modern broadcast receiving equipment can take alternative forms, such as computers with video adapters installed, nor is there any intention of limiting the term “media-playing set” to those sets adapted for television reception, it being recognized that other suitable media formats exist, such as programming received via the Internet or by radio. It will be noted that further details concerning the operation of the exemplary system of FIGS. 1 and 2 can be found in the related U.S. patent application referenced above.

II. Networked Geographical Setup

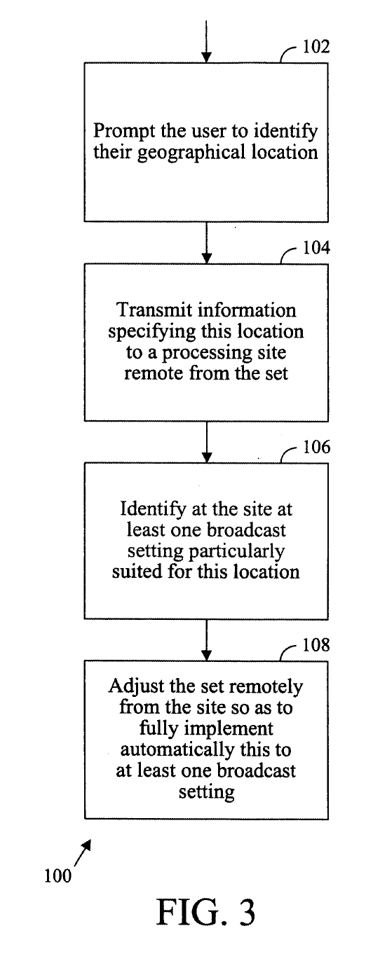

FIG. 3 outlines an exemplary method 100 for setting one or more broadcast characteristics of a media-playing set based on the geographical location of the user. The first step 102 comprises prompting the user to identify his or her geographical location. Such prompting can be made by a customer service representative 14 (FIG. 1) upon the user calling the remote site 12 with a support issue. Preferably, however, such prompting is done fully automatically, as by an executable script stored either in the set's memory 66 or on a setup disc or other removable media. This script can initially run when the set is first powered on and, thereafter for updating purposes, after a predetermined number of power-on cycles. Or the script can run periodically after a predetermined time interval, or whenever the user selects a location change button on the remote control 64 preferably dedicated for this purpose to provide one-touch control, or whenever the user selects a location change option via an on-screen menu, or whenever the set is connected with the remote site.

Although the user may be asked for his or her city, state or province, and country, a simpler, and hence preferred, form of query is to ask the user merely for the zip code where he or she is operating the set. This information sufficiently specifies the geographical location without requiring excessive data entry by the user and, in particular, can be easily entered on the number keypad of a remote control where “menu-free” control over the set has been implemented as discussed in the related U.S. Application referenced above. Moreover, the zip code correlates well with census information, such as that relating to socioeconomic status and other forms of commercially available data. Alternatively, another relatively intuitive approach is provided by presenting an on-screen interactive map having submaps the user can navigate through and zoom in or out of until he or she has pinpointed the set's location.

Step 104 entails transmitting information specifying this location to a processing site remote from the set. Though this information can be transmitted orally by the user to a customer service representative 14, preferably this information is electronically transmitted in accordance with the preferred mode of entirely automatic operation. For example, the executable script referred to above can, as part of it's instructions, automatically dial up the remote site 12 and, after ensuring secure connection is established between the remote networking unit 50 (FIG. 2) and the local set 60, can cause status information containing the location to be transmitted by the interface module 80 to the remote detector 85. In comparison to the set, the remote site has access to superior processing, data storage, and informational resources, and hence the site can better identify broadcast settings appropriate for the set given the location specified as further explained below.

Step 106 involves identifying at the remote site at least one broadcast setting particularly suited for this location. Indeed, in accordance with this method, multiple broadcast settings of multiple types are preferably remotely identified. One such broadcast setting is the clock setting (an improper clock setting adversely affects play and record times and hence falls within the above broad definition of a characteristic affecting the “broadcast”). Rather than requiring the user to locate a timepiece and to make sure that timepiece is accurately calibrated before using it to adjust the clock setting, the remote site is able, from the user's geographical location, to export a very accurate clock setting to the set. It performs this operation by using the location to identify the time zone of the user relative, for example, to Universal or Greenwich Mean Time and then accessing very accurate timing calibration signals available through official agencies such as the U.S. National Bureau of Standards. The clock setting, then, can be desirably synchronized for all users in a particular time zone so that when the remote detector 85 collects viewing preferences from users in a particular broadcast area for different day and time combinations, in order to cluster users with similar viewing preferences, equal recorded times actually represent equivalent real world times. This procedure is further described under Roman Numeral III.

Another broadcast setting preferably remotely identified based on the user's location is a listing of available channels or “channel map.” Here, the remote site is able to take advantage of commercial directories that list different broadcast stations (e.g., including television or radio) by location and by broadcast power and so is able to identify substantially all stations in the user's local broadcast area falling, for example, within a predetermined geographical radius or, more preferably, providing a signal of predetermined broadcast strength. This is preferable to the “scanning” approach conventionally used to construct the channel map which is not only relatively slow but can miss viable stations and add “phantom” ones.

After the remote site has identified the channels available for each set, it preferably groups user's together who share approximately the same channel availability as well as roughly corresponding socioeconomic status as indicated by zip code. This allows the remote site, for a given day and time, to specify a preferred channel setting for a particular user who is engaged in initial setup based on the viewing preferences previously recorded for other users with equivalent channel access and socioeconomic standing. Later on, after the viewing preferences of that particular user have been recorded, the remote site can specify, again for a given day and time, a preferred channel setting based on the previous viewing preferences of either the user themself or the experience of other users who enjoy the same types of programming. This is further discussed under Roman Numeral III below.

After the remote site has identified a preferred channel for each set for a given day and time corresponding to a particular program segment or “show,” it preferably then presents that channel for potential user selection, and also identifies other settings for the set that will optimize the broadcast of that segment or show. These operational settings can include setup settings (e.g., closed captioning, parental control, screen position, sleep mode), picture settings (e.g., brightness, backlight, color, contrast, tint, and sharpness), and audio settings (e.g., treble, bass, and balance). The picture and audio optimization process is further discussed under Roman Numeral IV below. The point here is that just by starting with minimal information, namely the user's geographical location, the remote site is able to systematically develop and propose a complete broadcast “solution” including mutually integrable setup, viewing, and operational settings that have been optimized relative to each other, so as to offer the user a fully optimized broadcast experience. The term “mutually integrable” is here intended to denote broadcast elements that can be presented simultaneously and coextensively in the form of a unified broadcast solution so that including one element does not necessarily preclude including the other. In contrast “mutually exclusive” elements would be two different channel settings since these two settings could not viably be combined in the same screen window (although two different channel selections could appear, as two different solutions, in separate screen windows).

Step 108 includes adjusting the set remotely from the site so as to fully implement automatically the broadcast setting or settings identified in step 106. The control signals initiating this adjustment are transmitted, for example, from the remote controller 72 and software agent 76 to the interface module 80 of the set, where they are relayed to the adjustment module 78 which, in turn, sends appropriate instructions to the other set components to make the adjustment. Since the adjustment is fully implemented automatically, adjustment is made independently of any further action by the user. For example, the user does not need recourse to the instructions to determine how to manually adjust the clock setting, which is not likely a setting that the user will be using with great frequency so as to make time spent deciphering the instructions worthwhile. Where the automatic adjustment involves the channel map, the user is provided ready and immediate access to all channels listed as suitable by the remote site, which listing is substantially more complete and generated much faster than under conventional approaches such as channel scanning.

Where automatic adjustment involves a channel setting and related picture and sound settings, preferably any channel setting that the user was viewing at the time is maintained on the screen so that the user can do a side-by-side simultaneous comparison of the old channel settings with the newly specified preferred or proposed settings, which new settings represent a fully optimized channel solution. Hence the user retains full discretion in deciding whether to adopt the new settings or to retain the old settings. As described in the related U.S. patent application referenced above, preferably the user, by conveniently operating a single button on the remote control (thumbs up or thumbs down) can indicate their approval or disapproval of the new settings.

III. Automatic Television Setup Based on Viewer Categorization

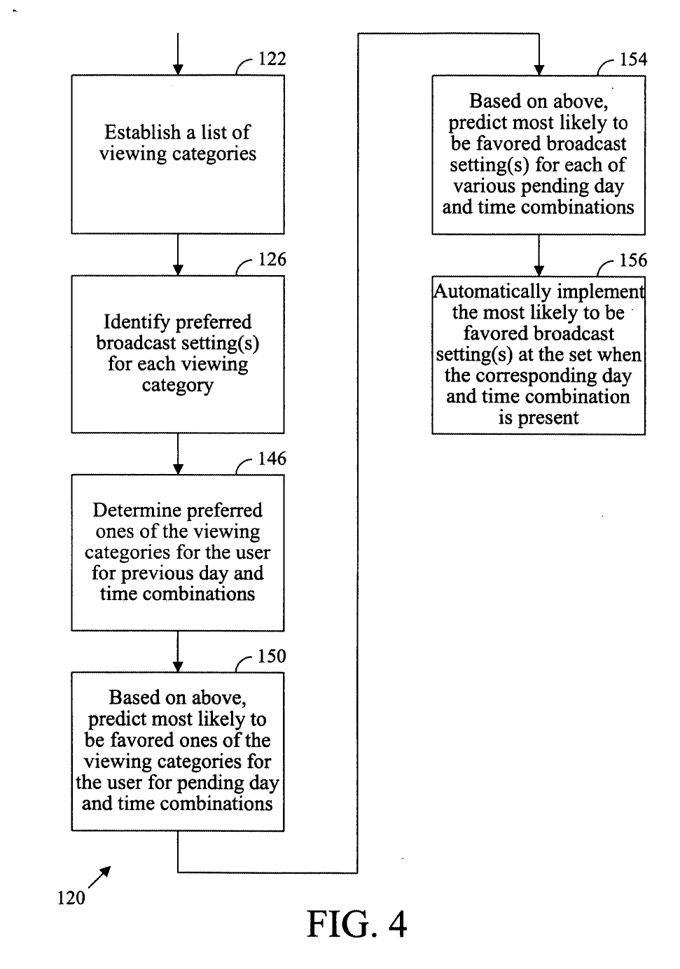

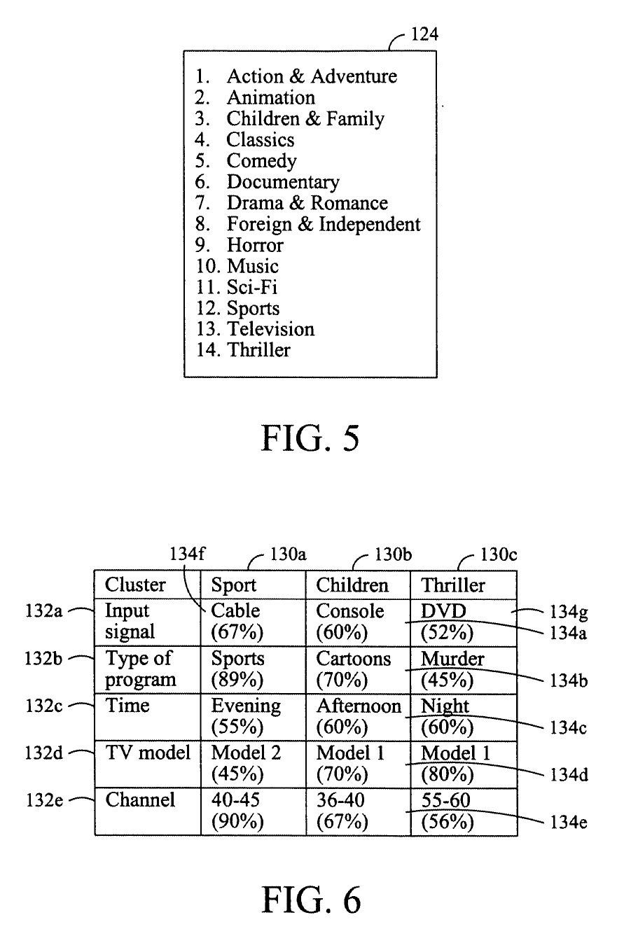

FIG. 4 outlines an exemplary method 120 for adjusting the broadcast settings of a media-playing set based on the viewing category most likely to be preferred by the user for a given day-of-week and time-of-day combination. Step 122 involves establishing a suitable list of viewing categories. Referring to FIG. 5, a representative list 124 of viewing categories is illustrated, which list includes individually numbered viewing categories such as “Action & Adventure,” “Animation,” “Children and Family,” “Classics,” “Comedy,” “Documentary,” and so on. The longer the list, the greater the processing power required at the remote site and the more closely the broadcast settings can be tailored to the user's viewing preferences.

Referring again to FIG. 4, step 126 involves identifying a preferred broadcast setting for each viewing category. As noted above, the term “broadcast setting” is intended to broadly denote any selection or choice that the user makes that can affect the broadcast transmission, including a setup setting (such as input source, parental control, the model of TV purchased, etc.), an operational setting (such as a picture, audio, or power setting), or a viewing setting (such as a channel setting or even the time-of-day or day-of-week chosen for viewing). On the other hand, a “surveillance” program surreptitiously running on the user's set to capture information on the user's viewing preferences for later transmission to a remote site, is not, for example, a broadcast setting even where updateable, since it does not affect the broadcast experienced by the user.

Referring now to FIG. 6 it will be noted that under the Children and Family viewing category 130b (here abbreviated as “Children”) that where the broadcast setting series (or “cluster) of concern is the input source setting 132a (here termed “input signal”) the preferred setting 134a is a conventional internal television antenna or “Console” and that such an input source is preferred in 60% of the results surveyed. For the “Sport” viewing category 130a, the preferred setting 134f for the input source series 132a is a Cable television link, preferred in 67% of the results surveyed. Here the term broadcast setting “series” refers to closely related broadcast settings that are mutually exclusive in relation to one another, that is, selecting one setting in the series precludes selecting the other. For example, for the input source or signal, the user can select either a cable link 134f, an internal antenna acting through the television console 134c, or an internal input feeding in from a DVD player 134g, but not all of these input sources at once.

Preferably, as also depicted in FIG. 6, more than one broadcast setting series is identified for each viewing category, and a corresponding list (e.g., 134a-e) of most preferred settings is identified for each viewing category (e.g., 130a). It may be noted that while the settings within a particular series cannot be simultaneously implemented in a “unified” solution, a group of settings in which each setting is taken from a different series can be so implemented or “mutually integrated.” Thus, for example, it is perfectly feasible to watch a children's cartoon via an internal television or “console” antenna in the afternoon on a particular TV model using either of channel settings 36-38 as suggested by the list of preferred settings 134a-e. As further explained below, preferably a “solution” comprising many different most likely to be favored settings is automatically implemented at the set thereby saving time and inconvenience for the user who would otherwise need to manually adjust each setting individually.

There are several ways of identifying which broadcast settings are “most preferred.” One way is to simply track the personal settings selected by the user for each type of viewing category and to identify those settings most preferred in each category. The large data storage capacity provided by the remote database 52 (FIG. 1) and superior processing capability of the remote processor 90 (FIG. 2) are helpful in implementing this approach. Another way is to identify those broadcast settings most preferred by broadcast experts. For example, a customer service representative 14 at the remote site or an artificial intelligence routine running automatically on the remote processor might identify a high sharpness setting as desirable for a “Sports” program, so that the user can follow any small objects in play, but a low sharpness setting for a “Classics” movie, so that the user is not distracted by the scratches and other flaws commonly found in older films.

Preferably, however, the list of “most preferred” broadcast settings are identified based on the accumulated experience of other users. This experience is vastly wider than the personal experience of the user, so there is less likelihood of missing or obsolete data points, particularly when, in accordance with the exemplary approach, this list is automatically updated continuously through dynamic networking of the remote site with these other users. The term “dynamic,” as used herein, is intended merely to suggest ongoing data flow between the remote site and the sets of the individual users in the network. The accumulated experience of these other users, moreover, when processed to identify the “most preferred” settings, represents a sort of collective wisdom or vote as to the particular settings that best optimize a program of the given viewing category. This procedure can be enhanced even further by filtering out of the list those broadcast settings most preferred by suspect categories of other users, such as indecisive users who switch between channels frequently or advanced users who do not share the preferences of and thus don't well represent most other users.

The representational format of FIG. 6 works well when the settings in the preferred broadcast series are limited to a discrete number of possibilities, such as cable, console, satellite, dvd, and computer for the input source series; morning, afternoon, evening, and night for the time series; and so on. Where the preferred settings take continuous values within a range, a more efficacious representational format is shown in FIG. 12. FIG. 12 shows, for example, that for the viewing category 130b of “Children,” the brightness series 132h has a preferred nominalized value of “plus 4” (item 134h). For the same viewing category, the backlight 132i, contrast 132j, treble 132k, bass 132i, and dolby 132m series have nominalized preferred values of minus 2.3 (item 134i), plus 1 (item 134j), minus 2.2 (item 134k), plus 4 (item 134i) and minus 1.7 (item 134m), respectively. Each of these settings are mutually integrable with each other, that is, each derives from it's own (continuous) series and together they form a group of settings that can presented simultaneously (and coextensively for the picture settings) as part of a “unified” solution. It will be further noted that the mutually integrable settings of FIGS. 6 and 12 can be combined with each other; for example, a children's cartoon broadcast in the afternoon on either of channels 36-40 and having the picture and sound settings indicated above would represent a preferred “solution” for the “Childrens” category 130b.

Thus far, only identification of the “most” preferred broadcast settings have been described. However, preferably the “next most” preferred broadcast setting, the “next most” after that, and so on, are also identified for each viewing category. FIG. 10, for example, identifies a relative ranking within the channel setting series 132e for the viewing category 130b of “Children.” As in FIG. 6, it can be seen that the “preferred” channel setting 134e in this series encompasses channels 36 to 40. However, in FIG. 10, it can also be seen that the “next most” preferred channel setting 136e for the Children's category encompasses channels 46 to 50 and that the “next most” preferred channel setting 138e after that encompasses channels 36 to 40. The relative ranking of each of these settings for the Children's category is indicated, here by the relative size of the pie slice, covering a “most preferred” to a “least preferred.” The purpose of ranking these mutually exclusive settings is that the user may decide, for example, after the “most preferred” channels 36-40 have been automatically implemented, that he or she still isn't satisfied and wants other channel options. If, for example, the user presses the channel setting control followed by a “thumbs down” button on the remote, the “next most” preferred channel setting, then the “next most” preferred after that, and so on, can alternatively be utilized.

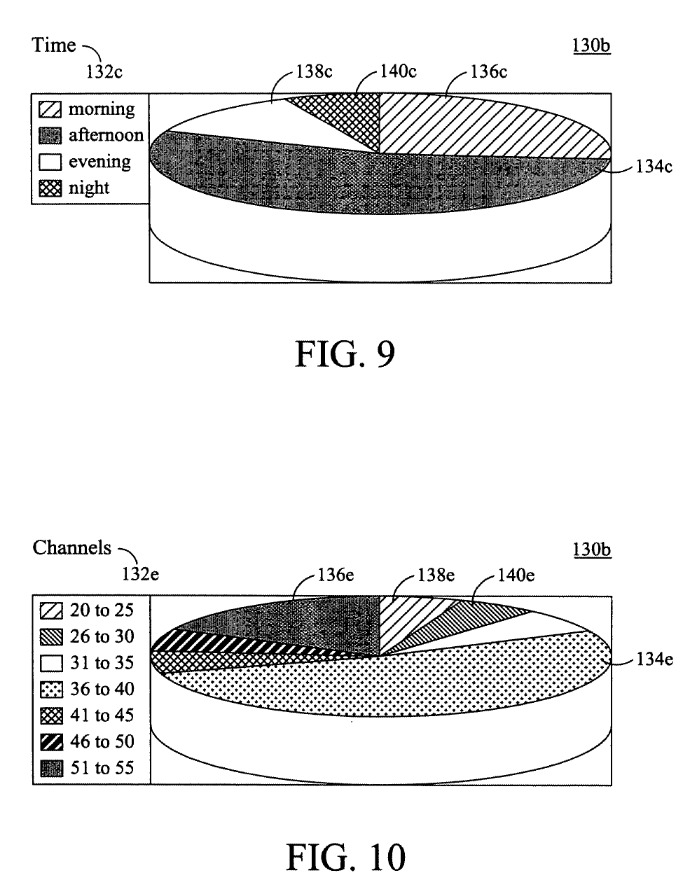

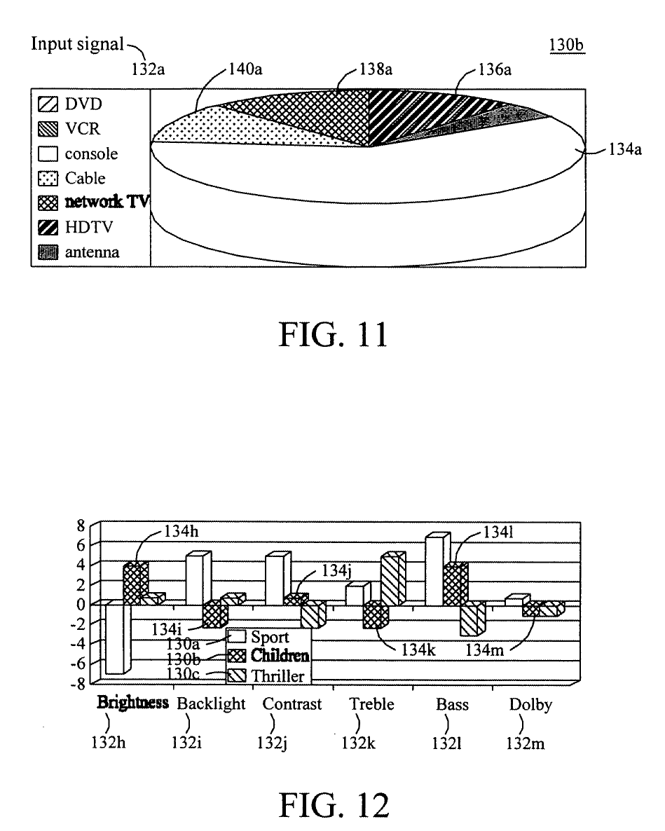

FIGS. 9 and 11 show a similar ranking of settings, again for the Children's category 130b, in FIG. 9 for the time setting series 132c and in FIG. 1 for the input signal or source series 132a. In FIG. 9, for example, the “most preferred” time for “Childrens” viewing is the afternoon 134c followed by the morning 136c, then the evening 138c, then the night 140c. Since the majority of “Children's” viewing occurs in the afternoon, if there is an indication the television is being used by children during this interval in an unauthorized manner (for example, the channel category is tuned to something other than “Childrens”), then a parental control lock can be automatically enabled, so that an adult viewer has to enter the password to restore television operation. FIG. 14 shows the corresponding on-screen display 142 flagging the issue for the adult viewer. Image 143 in FIG. 14 functions like a static tableau or visual desktop theme page and contains useful information confirming, for example, that connection is currently established between the user's set and the remote site.

Referring to FIG. 11, for the Children's category 130b, the most preferred input source setting 134a is the internal antenna available through the console, whereas the “next most” preferred setting 136a is a DVD feed, then the “next most” preferred setting 138a after that is a VCR feed. If unauthorized activity is indicated, for example, by a child attempting to connect to a paid cable television feed 140a, then once again automatic enablement of a parental control lock may be in order.

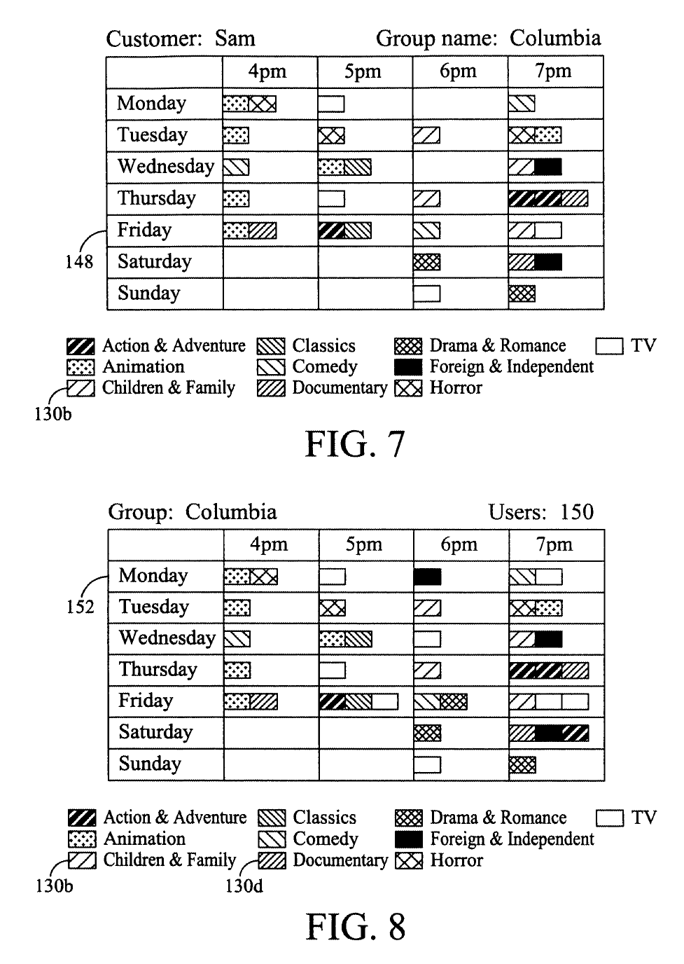

Referring to FIG. 4, step 144 of the exemplary configuration method 120 includes determining preferred ones of the viewing categories for the user for previous day-of-week and time-of-day combinations. A partial representation 146 of such information is shown in FIG. 7. Here we see that for a household identified with the user or customer name “Sam,” the preferred viewing category Wednesday at 4:00 p.m. is “Children and Family.” On Thursday at 7:40 p.m., the preferred viewing category is “Documentary, while on Sunday at 6:00 p.m., although the television is usually detected to be on (hence the generic “TV” label), no particular preferred viewing category has been identified. Preferably this information is accumulated for the user for all seven days of the week and for time-of-day intervals covering at least half hour increments. It will be noted that much of this information can mapped remotely if the user provides his or her geographical location, the input source is known, and the user's current channel selection can be remotely detected. That is, the remote site can determine, from commercially available program directories for example, that in zip code area 94520 on satellite channel 84 on Sunday at 1:00 p.m., the type of viewing category being broadcast is “Sports.” Alternatively, the remote processor 90 (FIG. 2) can decode the metadata accompanying each program segment or show and so determine that the show's general theme, for example, is “Sports.”

Based on the step above, step 150 of the exemplary method 120 includes predicting the most likely to be favored ones of the viewing categories for the user for pending day-of-week and time-of-day combinations. An exemplary representation 152 of such a prediction is shown in FIG. 8. The term “pending,” as used herein and in the claims, is intended to denote all present and future times. The term “present,” as used here and in the claims, is intended to signify imminent (nearly present) as well as manifestly present times.

Comparing FIGS. 7 and 8, it will be recognized that the viewing categories predicted to be most likely favored by the user (FIG. 8) are slightly different than the viewing categories determined to be preferred by the user (FIG. 7). It is possible to simply predict that the most likely to be favored categories simply equate to the categories already determined, based on the user's prior recorded or accumulated experience, to be the user's preferred categories. In that case FIG. 8 will be the same as FIG. 7. In the preferred embodiment, however, in predicting what the user will most likely favor, the user is “clustered” with other users whose preferred viewing preferences for previous day-of week and time-of-day combinations most closely match those of the user (note the high degree of similarity between the figures). This can be done using a statistical algorithm for minimizing cluster deviation, such as k-means or EM, which techniques will be evident to those of ordinary skill in the art. In this manner, the user can transcend their previous habits and take advantage of the accumulated viewing experience of like-minded users. For example, based on the experience of other users, the user is predicted to most likely favor a “Documentary” category 130d on Wednesday at 6:00 p.m., whereas formerly the user's habit was to keep the television off. Should the user adopt the related channel and other settings that are predicted to be most likely favored for this particular day-of-week and time-of-day combination (as explained below), they may discover a new and worthwhile program “favorite.” It will be apparent from this just why it is desirable to have a remote site 12 (FIG. 1) in networked relationship with vast numbers of individual sets 18 and which has the database 52 and processor 90 (FIG. 2) capabilities to store and continuously process the accumulated viewing and setting preferences of vast numbers of users. It will also be apparent that the internal clocks of the different sets are desirably closely synchronized and that the viewing categories mapped desirably represent the actual categories being broadcast, which goals can be obtained through a method such as described under Roman Numeral heading II above.

Referring to FIG. 4, the next step 154 involves predicting the most likely to be favored broadcast settings for each of various pending day-of-week and time-of-day combinations. The information needed to make this prediction will have already been gathered in the previous steps. For example, referring to FIGS. 7 and 8, it is predicted that the household identified as user Sam will most likely favor a program in the “Children & Family” viewing category on Wednesday at 4:00 p.m. along with all other 150 like-minded users clustered in the group labeled “Columbia.” Knowing that the most likely favored viewing category is “Children & Family,” we can use the “preferred” broadcast settings for that category 130b in FIGS. 6 AND 12 to predict the “most likely to be favored” broadcast settings (by simply equating the “preferred” and “most likely to be favored” settings-note here that the “preferred” settings already desirably reflect the accumulated experience of other users). Thus on Wednesday at 4:00 p.m., we can predict that the most likely to be favored channel setting will be one of channels 36-40 (the same as item 134e in FIG. 6), the most likely to be favored brightness setting will have a nominalized value of plus 4 (the same as item 134h in FIG. 12), the most likely to be favored treble setting will have a nominalized value of minus 2.3 (the same as item 134k) and so on for the rest of the setup, viewing, and operational (picture, sound, and power) settings. It will be apparent that the process can easily be repeated for another group of mutually integrable most likely to be favored broadcast settings when given a different day-of-week and time-of-day combination.

In FIG. 4, the final step 156 includes automatically implementing the most likely to be favored broadcast settings at the set when the corresponding day-of-week and time-of-day combination is present. Here and in the claims, as noted above, the term “present” is intended to mean imminent or nearly present as well as clearly present (a very small time interval between adjustment of the set and the start of a new program segment can be barely noticeable to the user). By automatically implementing the most likely to be favored broadcast settings, whether performed by the remote site 12 (FIG. 1) or by internally executing at the set a script containing prestored templates of “expert” settings, the user is not burdened with the inconvenient task of adjusting the set manually. This is particularly significant where a large group of mutually integrable settings, such as a channel setting and various picture and audio settings, are automatically implemented simultaneously as a complete broadcast “solution.” This saves the user the difficulty and time involved in attempting to manually adjust multiple settings in such a way that they are optimized in relation to each other.

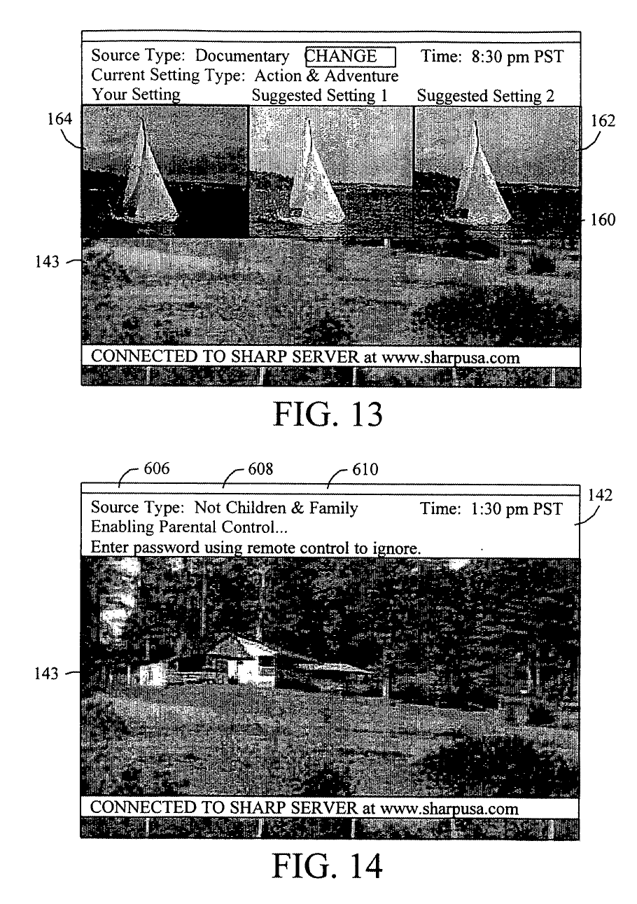

Referring to FIG. 13, to ensure that the user retains maximum flexibility in adjusting the set, preferably the user is presented with not just one broadcast solution 160 comprising the “most” likely to be favored settings but also with at least a second broadcast solution 162 where one or more of the constituent settings, say a picture setting, represents the “next most” likely to be favored setting(s). This provides the user with a visually intuitive side-by-side mode of comparison. At the same time, preferably the user's original settings or solution 164 are simultaneously maintained on-screen so that the user can compare all three solutions side-by-side and choose whichever one is most satisfactory, including reverting back to the original settings if desired. As in FIG. 14, image 143 functions as a static background image.

By operating suitable buttons on the remote control, such as a channel control button followed closely by a “thumbs down” button, preferably the user further has the option of requesting an entirely different set of mutually integrable settings. In this example, the “most” likely to be favored channel setting is automatically switched to the “next most” likely to be favored channel setting in accordance with the above discussion referencing FIG. 10. A similar process is preferably followed to cycle through different picture or sound options. Where the setting type takes a range of continuous values, such as picture or sound, the number of options desired can be identified, and a statistical algorithm can be used to determine those particular setting values about which the previous preferred settings most densely cluster for the same number of clusters as the number of options desired. It will be noted that where only the preferred or most likely to be favored setting is desired, there is only one option or cluster, and the result works out to an average. Further enhancements to the procedure of determining the preferred picture and audio settings are described below under Roman numeral heading IV.

IV. Broadcast Reception with Enhanced Picture and/or Audio Setup

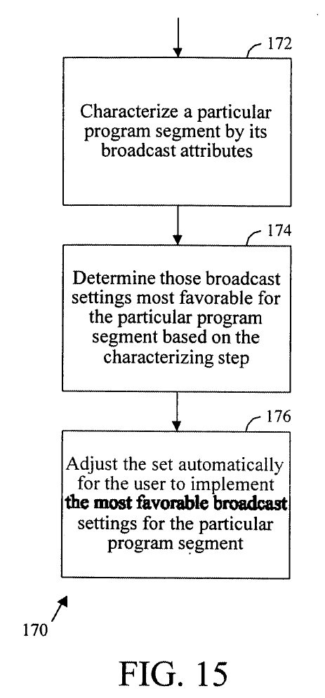

FIG. 15 outlines an exemplary method 170 for determining and implementing automatically those broadcast settings most favorable for specific programming content encountered by the user. Step 172 involves characterizing a particular program segment by at least one broadcast attribute. At the outset, it may be noted that this method operates on broadcast information deep at the particular segment or “show” level rather than at a higher level such as a general viewing category. In comparison to approaches, then, which offer “push-button” groups of settings for broad types of media content, this approach results in broadcast settings that are better tailored or optimized for the particular program segment encountered. The program segment being characterized can be one that is currently being broadcast and enjoyed by the user. If the component providing the characterization is a software agent running internally within the set, so that processing capacity is limited, the program segment can also be a prospective or upcoming segment in order to give the agent sufficient time to complete operations, in which case the broadcast attributes will be anticipated attributes.

The types of broadcast attributes used for characterizing a particular program segment can be various in nature and depend on the recording media involved. For example, an old classic movie may be recorded with a different aspect ratio, say 16:9, compared to the 4:3 aspect ratio of a modern movie, which aspect ratio, then, would be significant in properly specifying an on-screen position control (OPC) setting. Such a control was discussed in the above-referenced related U.S. patent application. Other useful attributes include the genre, hence a thriller movie may best be viewed using a lower brightness setting; the presence of animation, as this can affect the proper sharpness setting; the segment duration, as this can help an automated processor determine if the segment is a serial or a full-length movie; and the creation date.

The segment's creation date is significant because different segments recorded at about the same date often share common recording technologies and media attributes and thus often appear best using similar display settings. If an internal software agent is being relied on to execute this method so that processing capacity is limited, the segment's creation date can be estimated by analyzing the metadata associated with the particular program segment of concern. This metadata, which is a type of tag containing general data compiled about the accompanying program segment, will commonly list the director, the principal actors, and the presence of colorization, each of these being clues to the creation date of the segment, and may even directly list the production date.

Alternatively, where the set's characteristics can be monitored at a remote site having sufficient processing capability, the broadcast characteristics of the set can be evaluated while the program segment is running in order to directly measure the segment's broadcast attributes. Static picture attributes can be assessed by evaluating the contrast, brightness, hue, and color temperature using average, peak, and gradient analysis, and by further evaluating the spatial and spectral distributions of luminance and chrominance. Dynamic picture attributes, such as motion, can be assessed, for example, by analyzing interframe differences and frequencies. Audio attributes can be assessed by evaluating average, peak, temporal, and spectral auditory characteristics.

Referring to FIG. 15, step 174 involves determining those broadcast settings most favorable for the particular program segment based on the characterizing step. Desirably this is done by relying on an expert system, which in its simplest implementation can involve live customer service representatives 14 (FIG. 1) analyzing the attribute data collected about the program segment and then providing their experienced judgment to the user as to the most favorable settings for that segment. Preferably, however, the analysis process is conducted more systematically and efficiently under fully automated control.

One approach to automatically identifying the most favorable settings for a particular segment is to statistically analyze automatically the user's own prior experience to determine which settings the user has previously favored when viewing segments most close in attributes to the particular segment, and then reusing those same settings. A preferable approach, however, relies on collecting data automatically from a vast number of users and, based on the prior accumulated experience of those other users, statistically determining automatically which settings have been most favored when viewing segments most close in attributes to the user's particular segment. In this process it is further desirable to give greater weight to the experience of those other users who have actually or consciously selected segments most close in attributes to the user's segment (as opposed to those who may have left the room while leaving the set on so they were not even watching or listening when the programming switched to the substantially equivalent segment). A further refinement would be to weight even more heavily the experience of those user's who showed heightened interest in the substantially equivalent segment by switching to it immediately before or after the precise time-of-day the segment started. Conversely, the experience of suspect categories of users is preferably filtered out, such as other users who show disinterest by frequent shifting between segments or advanced users whose favored settings do not necessarily reflect normative selections.

Referring again to FIG. 15, step 176 involves adjusting the set automatically for the user to implement the most favorable broadcast settings for the particular program segment. This saves the user considerable time and inconvenience, for otherwise, the user would either have to tediously adjust manually each setting whenever a new segment came on or settle for less than optimal preexisting or “push-button” settings. Preferably, the set is automatically adjusted by a remote site 12 (FIG. 1) having sufficient processing resources 90 (FIG. 2) to efficiently deliver a solution comprising multiple settings optimized for the particular segment. Alternatively, however, the adjustment can be made under the local control of a software agent residing within the set; however, even here a remote site preferably is available for delivering updates to the software agent. In either case, preferably the set is automatically adjusted to implement new settings whenever one program segment concludes and another begins, whether due to the first segment reaching it's normal conclusion or to the user switching channels, so that the set is always updated with the optimal settings.

Where a local software agent is provided for adjusting the set, because of the inherent limitations on its processing capability, preferably also a local memory cache is provided in which different preselected groups of settings are stored so that the agent, in adjusting the set, can efficiently call on the particular group comprised of settings most closely matching those determined to be most favorable. Also, desirably the memory cache is indexed by assigning different identifier values to different program segments and assigning a different group of settings to each different identifier value such that there are fewer different groups of settings than there are different program segments. This can be done, for example, by “doubling up” or otherwise assigning the same identifier value to program segments of closely similar attributes. In this manner, the limited capacity of the local memory cache is conserved. Of course, more closely tailored groups of settings can be provided using a remote database 52 (FIG. 1) with its vastly greater memory space.

It will be apparent to those of ordinary skill in the art that equivalent operations can be supplied for performing the procedures and functions above described in connection with the exemplary embodiments. It will be further noted that the terms and expressions which have been employed in the foregoing specification are used therein as terms of description and not of limitation, and there is no intention, in the use of such terms and expressions, of excluding equivalents of the features shown and described or portions thereof, it being recognized that the scope of the invention is defined and limited only by the claims which follow.

I/We claim:

1. A method for helping end users configure their respective media-playing sets comprising the steps of:
(a) prompting the user to identify their respective geographical location;
(b) transmitting information specifying said location to a processing site remote from the set;
(c) identifying at said site at least one broadcast setting particularly suited for said location, and
(d) adjusting the set remotely from said site so as to fully implement automatically said at least one broadcast setting.

2. The method of claim 1 including identifying at said site a listing of channel settings particularly suited for said location.

3. The method of claim 1 including identifying at said site a clock setting particularly suited for said location.

4. The method of claim 1 including prompting the user for their zip code.

5. The method of claim 1 including identifying a channel setting particularly suited for said location.

6. The method of claim 5 further including identifying a preferred picture setting corresponding to said channel setting.

7. A method for helping end users configure their respective media-playing sets comprising the steps of:
(a) establishing a list of viewing categories and identifying a preferred broadcast setting for each viewing category;
(b) determining preferred ones of said viewing categories for the user for previous day-of-week and time-of-day combinations and, based thereon, predicting most likely to be favored ones of said viewing categories for the user for pending day-of-week and time-of-day combinations; and
(c) based on above steps, predicting a most likely to be favored broadcast setting for the user for each of various pending day-of-week and time-of-day combinations and automatically implementing said most likely to be favored broadcast setting at said set when the corresponding day-of-week and time-of-day combination is present.

8. The method of claim 7 further including identifying a list of the most preferred broadcast settings for each viewing category

9. The method of claim 8 further including identifying those broadcast settings most preferred by broadcast experts.

10. The method of claim 8 further including identifying those broadcast settings most preferred based on accumulated experience of other users.

11. The method of claim 10 further including automatically updating continuously said list through dynamically networking with said other users. (dynamic means automatic info flow)

12. The method of claim 10 further including filtering out of said list those broadcast settings most preferred by predetermined categories of said other users.

13. The method of claim 7 further including identifying a group of mutually integrable preferred broadcast settings for each viewing category.

14. The method of claim 13 wherein said group of mutually integrable preferred broadcast settings include broadcast settings taking a range of values.

15. The method of claim 13 wherein said group includes a channel setting and a picture setting

16. The method of claim 13 further including predicting a group of mutually integrable most likely to be favored broadcast settings for the user for each of various pending day-of-week and time-of-day combinations.

17. The method of claim 16 further including automatically implementing a broadcast solution at said set where said broadcast solution is simultaneously comprised of said mutually integrable most likely to be favored broadcast settings of said group.

18. The method of claim 17 further including automatically implementing a second broadcast solution at said set such that the user can select either solution

19. The method of claim 18 wherein each of said broadcast solutions include the same channel setting and a different picture setting, said picture settings including the most likely to be favored and next most likely to be favored picture settings for the viewing category to which said channel setting belongs.

20. The method of claim 7 further including identifying a next most preferred broadcast setting for each viewing category mutually exclusive in relation to said preferred broadcast setting.

21. The method of claim 20 further including predicting a next most likely to be favored broadcast setting for the user mutually exclusive in relation to said most likely to be favored broadcast setting.

22. The method of claim 21 further including automatically implementing said next most likely to be favored broadcast setting at said set in the event the user requests a different option.

23. The method of claim 7 further including identifying a ranking of mutually exclusive broadcast settings for each viewing category indicating relative ranking of said mutually exclusive broadcast settings covering a most preferred to a least preferred.

24. The method of claim 23 wherein said ranking includes a first, a second, and a third channel setting.

25. The method of claim 7 further including predicting said most likely to be favored ones of said viewing categories for said user based on accumulated experience of the user.

26. The method of claim 7 further including predicting said most likely to be favored ones of said viewing categories for said user based on accumulated experience of other users.

27. The method of claim 26 further including relying on said accumulated experience of those other users whose preferred viewing preferences for previous day-of-week and time-of-day combinations most closely match those of the user

28. The method of claim 27 further including determining those other users by using a statistical clustering algorithm.

29. The method of claim 7 further including providing a remote site and automatically implementing remotely said most likely to be favored broadcast setting.

30. The method of claim 29 further including simultaneously maintaining any broadcast setting originally set by the user to enable the user to choose between said original and most likely to be favored broadcast settings.

31. A method for helping end users configure their respective media-playing sets comprising the steps of:
(a) characterizing a particular program segment by at least one broadcast attribute;
(b) determining those broadcast settings most favorable for said particular program segment based on said characterizing step; and
(c) adjusting said set automatically for said user to implement said most favorable broadcast settings for said particular program segment.

32. The method of claim 31 further including characterizing a particular program segment currently being broadcast

33. The method of claim 31 further including characterizing an upcoming particular program segment by at least one anticipated broadcast attribute.

34. The method of claim 31 wherein said at least one broadcast attribute includes an attribute taken from the following group: aspect ratio, genre, animation, segment duration, and segment creation date.

35. The method of claim 31 further including estimating the creation date of said particular program segment by analyzing metadata associated with said segment.

36. The method of claim 31 further including inferring said at least one broadcast attribute from compiled data available for said particular program segment.

37. The method of claim 31 further including deriving said at least one broadcast attribute by evaluating at least one broadcast characteristic of said set as said particular program segment is being broadcast.

38. The method of claim 31 further including relying on an expert system to determine those broadcast settings most favorable for said particular program segment.

39. The method of claim 38 further including relying on an automated expert system.

40. The method of claim 39 further including determining those broadcast settings deemed to be most favorable based on the prior experience of the user.

41. The method of claim 39 further including determining those broadcast settings deemed to be most favorable based on the prior experience of other users.

42. The method of claim 41 further including giving greater weight to the experience of those other users who have actually selected previously program segments substantially equivalent in terms of said at least one broadcast attribute to said particular program segment.

43. The method of claim 41 further including filtering out the experience of those other users falling into a suspect category.

44. The method of claim 31 further including adjusting said set automatically whenever one program segment concludes and another program segment begins.

45. The method of claim 41 further providing a remote support site and remotely adjusting said set from said site.

46. The method of claim 41 further including providing a software agent with said set and locally adjusting said set by said agent.

47. The method of claim 45 further including providing a memory cache with said set in which different preselected groups of settings are stored so that said agent, in adjusting the set, can call on the particular group comprised of settings most closely matching those determined to be most favorable.

48. Indexing the memory cache by assigning different identifier values to different program segments and assigning a different group of settings to each different identifier value such that there are fewer different groups of settings than there are different program segments.
